(19) United States
(12) Patent Application Publication
(10) Pub. No.: US 2021/0349587 A1
(43) Pub. Date: Nov. 11, 2021

(54) PIXEL-BASED OPTIMIZATION FOR A USER INTERFACE

(71) Applicant: Apple Inc., Cupertino, CA (US)

(72) Inventors: Jeffrey P. BIGHAM, Pittsburgh, PA (US); Colin S. LEA, Pittsburgh, PA (US); Jason WU, Pittsburgh, PA (US); Xiaoyi ZHANG, Shoreline, WA (US)

(21) Appl. No.: 17/067,601

(22) Filed: Oct. 9, 2020

Related U.S. Application Data
(60) Provisional application No. 63/021,047, filed on May 6, 2020.

(51) Int. Cl. G06F 3/0484; G06F 3/0488

(52) U.S. Cl. CPC G06F 3/0484; G06F 3/0488

(57) ABSTRACT

Representative embodiments set forth techniques for optimizing user interfaces on a client device. A method may include receiving a spatial difficulty map associated with the user interface. The method also includes identifying one or more user interface elements using an element detection model and generating a user interface layout based on at least the spatial difficulty map. The method also includes generating an updated user interface by editing the one or more user interface elements using the user interface layout and rendering, on a display of the client device, the updated user interface.

### CROSS-REFERENCE TO RELATED APPLICATIONS

The present application claims the benefit of U.S. Provisional Application No. 63/021,047, entitled “PIXEL-BASED OPTIMIZATION FOR A USER INTERFACE,” filed May 6, 2020, the content of which is incorporated herein by reference in its entirety for all purposes.

### FIELD

The described embodiments relate generally to pixel-based optimization, and in particular to systems and methods for implementing pixel-based optimization for mobile user interfaces.

### BACKGROUND

A long-standing challenge in human-computer interaction is to automatically personalize user interfaces (UIs) to the current user's context and abilities. In practice, UIs are created with many different toolkits, each of which exposes different semantics and provides for personalization only in limited pre-defined ways, which makes personalization of existing UIs across a whole platform especially difficult.

### SUMMARY

In view of the challenges in personalizing user interfaces (UIs) for mobile device users, one or more embodiments described herein include systems and methods that optimizes mobile UIs for a given input difficulty map using only the pixels of the UI.

Accordingly, one embodiment sets forth a method for personizing a user interface on a client device includes receiving a spatial difficulty map associated with the user interface. The method also includes identifying one or more user interface elements using an element detection model and generating a user interface layout based on at least the spatial difficulty map. The method also includes generating an updated user interface by editing the one or more user interface elements using the user interface layout and rendering, on a display of the client device, the updated user interface.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings, which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an example network environment including an electronic device that may implement the subject system, according to some embodiments.

FIG. 2 illustrates an architecture of a neural scoring model for scoring a user interface screen, according to some embodiments.

FIG. 3 illustrates a user interface personalization method, according to some embodiments.

FIG. 4 illustrates a detailed view of a computing device that can represent the electronic device of FIG. 1 used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in enough detail to enable one skilled in the art to practice the described embodiments, it is understood that these examples are not limiting such that other embodiments can be used, and changes can be made without departing from the spirit and scope of the described embodiments.

As described, a long-standing challenge in human-computer interaction is to automatically personalize user interfaces (UIs) to the current user's context and abilities. In practice, UIs are created with many different toolkits, each of which exposes different semantics and provides for personalization only in limited pre-defined ways, which makes personalization of existing UIs across a whole platform especially difficult.

Accordingly, systems and methods, such as those described herein, that optimize mobile UIs for a given input difficulty map using only the pixels of the UI, may be desirable. The systems and methods described herein may be applied to any UI, regardless of what underlying toolkit or platform was used to create it. The systems and methods described herein explore eye gaze and one-handed touch input for which errors and time to selection (“difficulty”) are spatially dependent on target location. The systems and methods described herein may be configured to allow users to first create a spatial difficulty map. The systems and methods described herein may then (i) automatically identify UI elements, (ii) optimize layout according to the difficulty map, and (iii) render and refine the resulting screen to preserve visual aesthetics. In a user study (n=10), the systems and methods described herein automatically optimize UI layouts to facilitate faster, more accurate interaction. Additionally, or alternatively, the systems and methods described herein illustrate that complex personalization of UIs can be done using only pixel information, and thus may find application in enabling many different kinds of personalization and ability-based design on many different platforms in practice.

Users often find themselves needing to respond to emails or look up information when walking, holding a shopping bag, or otherwise situationally impaired. These situations highlight the dynamic and context-driven nature of mobile computing, which presents challenges for designing usable and accessible applications. Even when app developers follow the best mobile app design practices, they may still find it difficult to account for the wide range of usage contexts. In fact, while design guidelines promote behaviors that are generally desirable, the implicit assumptions they carry may not always be accurate for all users (e.g.. the optimal font size may be different for near-sighted users or when in motion). Addressing this issue is part of the goal of ability-based design, which advocates for application to account for and adapt to users [42]. However, in practice, the amount of personalized benefit from these systems largely varies due to the cost and effort required to implement ability-based design.

The systems and methods described herein enable application-specific optimization without requiring app source code or additional work from developers. By detecting, optimizing, and re-rendering mobile app screenshots, the systems and methods described herein may re-layout UIs based on a personalized spatial difficulty model. The systems and methods described herein may be configured to spatially model interaction difficulty for two input modalities, one-handed touch and gaze-tracking, which are often not considered in mobile app designs. The systems and methods described herein may use this model to train a neural scoring function for estimating the usability of a UI. The systems and methods described herein may use such scoring functions to optimize an existing UI layout in the direction to improve usability. Additionally, or alternatively, the systems and methods described herein may provide for a UI re-layout decrease the input error rate by, up to, 10%, while reducing task completion time by, up to, 20%.

In some embodiments, the systems and methods described herein may be configured to model the spatial biases of interaction difficulty from multiple factors (i.e., input error and speed) and efficiently predict the usability of a screen using our neural scoring function. The systems and methods described herein may be configured to automatically optimize existing apps based on usage context without requiring source code or additional effort from app developers.

In some embodiments, the systems and methods described herein may be configured to provide end-to-end optimization for existing third party apps, using only pixels to adapt to a user's abilities. The systems and methods described herein may execute an application that uses a list to display options, which may present interaction challenges for users with motor or situational impairments (e.g., one-handed use). The systems and methods described herein may automatically optimize the layout of on-screen elements for the current usage context.

Typically, mobile device apps are designed for touch-based interaction. Therefore, mobile apps are relatively difficult to use with alternative input modalities (e.g., such as gaze input). The systems and methods described herein may be configured to provide optimizations that can significantly improve usability for alternative input modalities with personalization.

In some embodiments, the systems and methods described herein may be used in ability-based design, which aims to present an app's functionality in a way that is most compatible and beneficial to a user's abilities. The systems and methods described herein may be configured to enable mobile devices to adapt to a user's abilities and preferred mode of interaction by generating spatial difficulty maps from a calibration task. Temporary factors (e.g., situation impairments, environmental conditions, user's pose) can also significantly affect mobile interaction. The systems and methods described herein may be configured to automatically infer these contextual data in an unobtrusive, privacy preserving manner (e.g., monitoring and measuring errors in users' day-to-day usage data). In some embodiments, the systems and methods described herein may be configured to run in the background (e.g. as a background application of a mobile computing device or other suitable device).

In some embodiments, the systems and methods described herein may be configured to automatically optimize existing third-party mobile apps using pixel-based techniques. Without using a mobile application's source code or any additional effort from developers, which may improve or maximize the potential for end-users to benefit. The systems and methods described herein may be configured to integrate a spatial model of difficulty to optimize mobile app screens from corresponding pixel data.

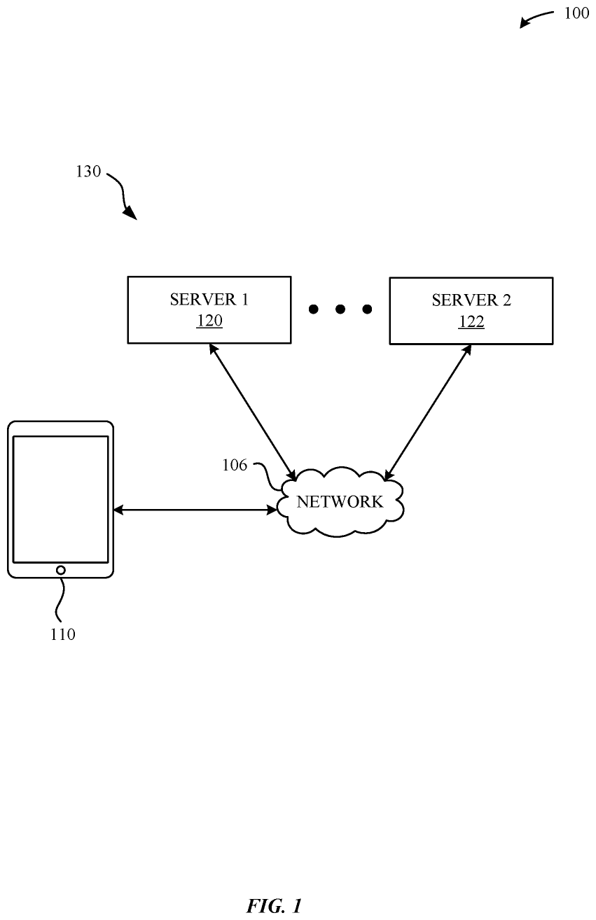

FIG. 1 illustrates an example network environment 100 including an electronic device 110 that may implement the subject system in accordance with one or more implementations. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network environment 100 includes the electronic device 110, a server 120, and a server 122 in which the server 120 and/or the server 122 may be included in a group of servers 130. The network 106 may communicatively (directly or indirectly) couple, for example, the electronic device 110 with the server 120 and/or the server 122 and/or the group of servers 130. In one or more implementations, the network 106 may be an interconnected network of devices that may include, or may be communicatively coupled to, the Internet. For explanatory purposes, the network environment 100 is illustrated in FIG. 1 as including the electronic device 110, the server 120, the server 122, and the group of servers 130; however, the network environment I 00 may include any number of electronic devices and any number of servers or a data center including multiple servers.

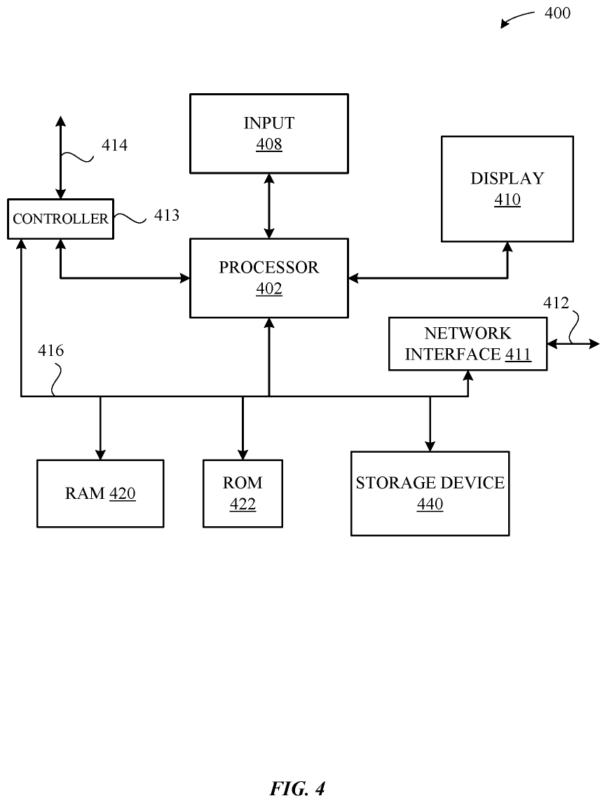

The electronic device 110 may include a touchscreen and may be, for example, a portable computing device such as a laptop computer that includes a touchscreen, a smartphone that includes a touchscreen, a peripheral device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 110 may not include a touchscreen but may support touchscreen-like gestures, such as in a virtual reality or augmented reality environment. In one or more implementations, the electronic device 110 may include a touchpad. In FIG. 1, by way of example, the electronic device 110 is depicted as a mobile computing device with a touchscreen. In one or more implementations, the electronic device 110 may be, and/or may include all or part of, the electronic system discussed below with respect to FIG. 4.

The electronic device 110 may implement the subject system to provide graphical user interfaces and animations. In one or more implementations, the electronic device 110 may include a framework that is able to support graphical user interfaces and animations, which may be provided in a particular software library in one implementation. For example, the electronic device 110 may be configured to implement a software architecture capable of executing the methods described herein.

The server 120 and/or the server 122 may be part of a network of computers or the group of servers 130, such as in a cloud computing or data center implementation. The server 120, the server 122, and/or the group of servers 130 may store data or data collections, such as photos, music, text, web pages and/or content provided therein, etc., that may be accessible on the electronic device 110. In one or more implementations, the electronic device 110 may support a UI operation that involves a representation of a data collection that is partially physically stored on the electronic device 110 and partially physically stored on the server 120, the server 122, and/or one or more servers from the group of servers 130, such as an image file, text, sound file, a video file, an application, etc. For example, the electronic device 110 may be configured to generate a visual representation of a data collection, using the UI operation. Additionally, or alternatively, the electronic device 110 may be configured to generate a visual animation of the data collection transitioning from a current view to a future view. In some embodiments, the electronic device 110 may be configured to optimize mobile UIs for a given input difficulty map using only the pixels of the user interface (UI).

Sources of Interaction Difficulty

While the nature of mobile computing is contextual and dynamic, previous research has shown that some of the factors affecting interaction difficulty can be modeled. Compared to exact pointing methods used on traditional desktop interfaces (e.g., mouse), touch input is less precise. This is often attributed the ambiguity introduced by a deformation of a finger upon contact with the screen. Common situational impairments, such as mobility and one-handed usage, introduce additional challenges, such as grip comfort and interaction speed. These factors also vary spatially and are also influenced by device size and finger size.

Gazed-based interaction has been explored as an alternative input modality for smartphones for certain usage contexts (e.g., hands-free interaction [18], accessibility [43]). Gaze tracking may also exhibit similar spatial biases as touch interaction (e.g., which may be due to the difficulty of localizing the pupil at certain angles). Additionally, or alternatively, the sources and characteristics of error for gaze-tracking systems often vary widely between setups and environmental conditions, highlighting the need for a dynamic, context-aware approach to modeling difficulty.

In addition, several factors that influence interaction difficulty, such as priori spatial biases (e.g., a user would find it more difficult to tap targets located far away from the resting position of their fingers) and not those that are dependent on a specific task being performed (e.g., successively accessed UI elements should be located close together).

Spatial Representation of Difficulty

The electronic device 110 may be configured to account for a plurality of factors, such as factors influencing interaction difficulty. The factors may include (i) input error, (ii) selection speed, (iii) other suitable factors, or a combination thereof. It should be understood that the electronic device 110 may account for a plurality of additional components to interaction difficulty (e.g., comfort, confidence), than those descried herein.

In some embodiments, these two components are measured spatially using a calibration task which involves repeatedly selecting targets that appear at random locations on the screen. Input error is calculated as the offset between the actual target location and the user input location. The time between the target's appearance and its selection may be measured, as will be described. The results of this calibration task may be represented as spatial maps where each location on the device's screen is mapped to a value. At each point, input error is represented as a vector (forming a vector field), and selection time is represented as a scalar (forming a scalar field).

As reflected in many models of interface throughout and error modeling, there exists an inherent tradeoff between speed and accuracy. This may be reflected by Fitts's law, which describes, among other things, a logarithmic relationship between movement time and target size. One intuition is that a user-controlled pointer successively approaches the target in discrete steps, where each step takes roughly the same time and brings the pointer closer to the target by a fraction of the distance at the start of the step. This process completes when the pointer's distance is within a “margin of error” (i.e., target width), hence Equation 1. While the standard arrangement of the formula is meant to predict the movement time needed to reach an object.

t=a+b·log2(2A/W) (1)

The standard Fitts' law formulation can be used to estimate the speed-accuracy tradeoff for applications controlled by 1-D and 2-D pointing. However, it may be difficult to apply the standard Fitts' law equation due to a constraint of modeling these factors independent of a task. Without a known sequence of expected actions, it is difficult to calculate A and W as originally defined by the equation.

Thus, the standard formula is adapted, incorporating relevant aspects of the original model into the formulation, which may be used to adapt the existing model to the constraints described herein. A user's finger, initially located at location pi on the electronic device 110 touchscreen, may select a target located at location p on the electronic device 110 touchscreen, which is located a distance A away. The finger approaches the target point pt, but ultimately may deviate from the optimal path and lands at its actual final position, pf which is located a distance rf away from the pt. Since rf A, A≈∥Pₜ−Pᵢ∥, making W negligible. Thus, with A representing the distance between pi and pf, the time needed to traverse the distance is shown by Equation 2.

t=a+b·log2(A) (2)

Computing A directly may include measuring pi using a variety of techniques (e.g., motion capture technology, capacitive measurement, and computer vision). However, it may be impractical to use additional instrumentation for real-world user calibration, (e.g., so that \tilde{ } pi can be estimated from data).

If pi is assumed to be relatively similar among users, it is possible to empirically learn this location. In some embodiments, a baseline for identifying the location of fingers when comfortably gripping the electronic device 110 may include a trendline between dimensions of the electronic device 110 and the centroid of the comfortable area to estimate the projected location of pi on the electronic device 110 touchscreen. In some embodiments, pi may be determined using a dataset as a part of the Fitts' model parameters by re-defining the distance term (Equation 3).

A=∥Pf−\tilde{p}ᵢ∥ (3)

To do this, in addition to the standard Fitts' model parameters a and b, p\tilde{ } i may be identified by fitting the following equation to a dataset of pairs hti, pf i using non-linear ordinary least squares.

In some embodiments, both approaches may be tested under assumptions of 2-D (i.e., piz=0) and 3-D movement (piz ∈(0,1]z). Since the baseline model predicts a 2-D point, its z-component may be determined as part of the fitting process when considering 3-D movement.

Using an estimate of A, a spatial error map (a 2-D vector field) is normalized by a spatial time map (a 2-D scalar field) by estimating the trajectory of the user's finger. Assuming the trajectory roughly resembles a line passing through pi and pf, the radius of error can be computed by Equation 5, where x is the distance from pi and y is the radius of error.

((0,ri,1)×(A,rf,1))(x,y,1)T=0 (4)

y=(((rf−ri)·x)/A)+ri (5)

x=2b tn−a (6)

One of the previous models is then used to compute the normalized error re at constant time tn. The model is meant to provide a starting point for combining selection error and selection time data. In the original formulation (Equation 1), A represents the distance between targets on the screen (i.e., a 2-D plane). This has the important implication that the distance between successively accessed UI elements should be close. In addition, the model assumes that the trajectory of the finger is well-described by a line passing through pi and pf, so that the selection radius varies linearly along the Z dimension.

UI Scoring Function

In some embodiments, the electronic device 110 or other suitable computing device may minimize the expected error from a user interface. For example, the electronic device 110 may model error for different modalities and predict the usability of UIs under the circumstances. Each UI element using may be represented by parameters θ=[x,y,w,h], describing the location and size of its bounding box. A screen is represented by the set of its elements Θ={θ1,θ2, . . . ,θn}.

$$S ( Θ ) = {Σ}^{″} Pθ dA \\ θ ∈ Θ \\ R θ \qquad ( 7 )$$

Pθ represents the normalized distribution of predicted points as a 2-D normal distribution at the center of the UI element.! when the user selects θ so that Pθ dA=1. This may be modeled as:

Pθ=N(θ,σ2) (8)

Instead of directly computing S(Θ) by integrating over each UI element's selection region (which is complicated by nonlinearities introduced by input techniques such as bubble cursor), the electronic device 110 may use a Monte Carlo approach to estimate S(Θ).

For each element, the electronic device 110 may sample the error map for the mean directional gradient and variance at that point and may draw samples from a parameterized distribution. For each element, the electronic device 110 may draw n=30 points. The electronic device 110 may score a screen by counting the number of true positives over total number of points. Using this scoring function, the electronic device 110 may use a black-box minimization based on Gaussian Process Regression to optimize the parameter set.

Neural Network Scoring Function

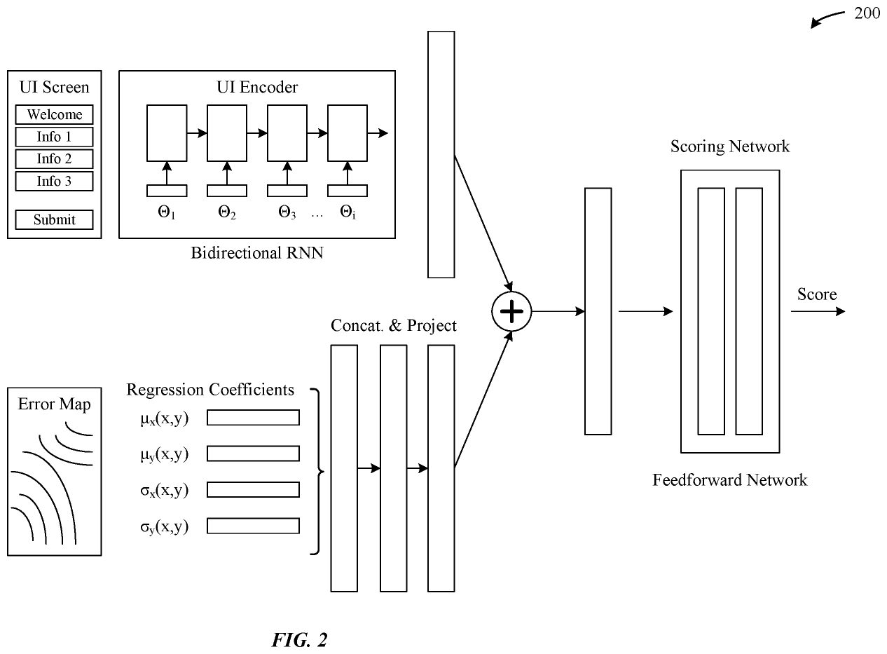

In some embodiments, the electronic device 110 may be configured to use a neural scoring model, such as a neural scoring network 200 illustrated in FIG. 2, for scoring a user interface screen given a spatial map of error. The network 200 encodes the layout of UI elements using a bidirectional RNN and encodes the spatial error map using the coefficients of a 2-D polynomial function fitted to the calibration points. These encoded representations are combined and fed into a feedforward network.

The network 200 to learn a function approximation of the scoring function, where the outputs were computed using the Monte Carlo function, which may allow the scoring function to be smooth and differentiable, allowing for much easier optimization. The network 200 may use an encoder to encode screen's UI elements into a fixed-size hidden vector. An additional vector is created by projecting the auxiliary inputs into the same dimensionality and is used to condition the encoded UI. The conditioned representation is then fed into a multi-layer perceptron (MLP) for estimating the score. A bidirectional gated recurrent unit (GRU) is used to encode the UI. In some embodiments, the effect of vulnerable to input ordering is minimized by always ordering the elements of the UI from smallest to largest to sure a given UI screen is always represented consistently. To encode each difficulty map, a bivariate polynomial is fit to the input map and used the coefficients as features, which are then encoded and combined with the UI information before making a prediction.

In some embodiments, the network 200 may be trained using an suitable technique. The model may be trained using a training portion of the data described herein. In some embodiments, the network 200 may trained for 800 epochs (e.g., or any suitable number of epochs) using a batch size of 1 (e.g., or any suitable batch size) and a cyclical learning rate schedule linearly oscillating between lrbase=0.0005 and lrmax=0.001 (e.g., or any suitable range). A loss function of the model may be defined as the absolute value of the difference of its output and the value computed using our Monte Carlo scoring function. Parameters of the mode may be saved after each epoch, and may use a checkpoint with the lowest validation loss (lbest=0.016).

In some embodiments, the electronic device 110 may be configured to automatically detect, optimize, then re-render an existing application's UI without requiring any source code or exposed application semantics. The electronic device 110 may perform an end-to-end optimization process that includes, at least: (i) Element Detection, (ii) Layout Optimization, and (iii) Rendering & Refinement. In some embodiments, the electronic device 110 may first extract the location of UI elements using an element detection model. The layout's parameters are then optimized with respect to the scoring model's output and semantic constraints. The refined layout is then used to re-render the UI screen by automatically editing the original pixel data.

Element Detection

In some embodiments, the electronic device 110 may first use an element detection model to semantically represent the UI screen as a list of bounding boxes, which can be used by the neural scoring function for optimization. Apps developed using the default UI toolkits for an operating system associated with the electronic device 110 may provide representations of screen layouts through metadata about on-screen elements, including location and type (e.g., Button, Textbox). This information is often accessed by other system programs, such as a screen reader, to provide alternative ways of accessing content. However, apps developed using, for example, third party app development libraries and a software development kit, may not include this metadata.

In some embodiments, the electronic device 110 may operated under minimal assumptions about the amount and type of information accessible to the electronic device 110. Regardless of what UI toolkit is used, all mobile applications render content and controls to the screen for display to the user. To convert a visual representation of an app (i.e., a rendered screen) to a semantic one (i.e., location and types of UI elements), the electronic device 110 may use an object detector trained to detect UI elements from a screenshot. The object detector may be based on any suitable neural network architecture for single-shot object detection and returned bounding boxes for UI elements that it detected from an input image.

In some embodiments, the model may be trained using a suitable number of application screens, such as a dataset of 89000 application screens or other suitable number of application screens. Each screen's UI elements of the dataset may be labeled as bounding boxes by crowd-workers. In some embodiments, screenshots may be downsampled in the dataset by a factor of 2 (414×896), to train the model. The object detector model may be defined using a suitable machine learning framework configured to automatically estimated and set training hyper-parameters. In total, the model may be trained for 48000 steps (e.g., or any suitable number of steps) with a batch size of 128 (e.g., or any suitable batch size), which may result in a final mean average precision (mAP) score of 0.81 when using a threshold (e.g., an IOU or other suitable threshold) of 50%.

Layout Optimization

Once the UI screen is transferred to the semantic domain, the electronic device 110 use the scoring model to evaluate and optimize the layout of the UI screen. Because the neural network 200 is used to approximate the scoring function (Equation 7), the model provides a differentiable function with which the electronic device 110 can use optimize its input parameters. Specifically, the electronic device 110 may feed a parameterized layout to the scoring model to compute the score of the parameterized. Using the computation graph from this evaluation, the electronic device 110 may compute the derivative of the model output (S(Θ)) with respect to the input (Θ).

In some embodiments, a regularization term is added that adds a penalty for layouts that are proportionally dissimilar. This regularization term is defined as the cosine distance (DC) between the pairwise L1 distances of each UI element (φ(Θ)). The intuition of this formulation is that since the cosine similarity (i.e., 1 cosine distance) computes the angle between two vectors, it does not penalize the layout for increasing in size but still maintains elements' relationships with neighboring ones. The electronic device 110 may use the L-BFGS minimization algorithm to find the optimal layout parameters with a learning rate of lr=0.001 or other suitable learning rate.

J=−S(Θ)+λreg DC(φ(Θ0),φ(Θ)) (9)

After each optimizer step, the electronic device 10 may clamp the parameters to stay within a certain range, to prevent elements from invisible or too large. Additionally, or alternatively, the electronic device 110 may feed the layout into an algorithm that removes overlaps between elements. For each element that contains overlaps, the electronic device 110 may calculate the dimensions of each overlapping region and sum them together. The element's position is then updated using the smaller of the two axes. This process is repeated until no more overlaps are detected or a max number of iterations is reached. The electronic device 110 may implement an early stopping condition that is triggered when the overlap removal algorithm detects overlaps that are unresolvable (i.e., cannot be resolved by moving elements further apart).

Rendering & Refinement

Following the layout optimization, the electronic device 110 may produce an interactive visual output by re-rendering the modified parts of the UI. First, the interactive regions for the UI screen are modified so that they correspond to the optimized layout (e.g., clickable bounding box a button is updated to reflect its new optimized position). To align the screen's visual appearance with these new regions, image patches from the original screen may be translated and resized to their new locations. A problem with naive resizing (i.e., scaling) techniques is that certain visual content, such as text, can be distorted in a way that negatively impacts appearance and readability. The electronic device 110 may use a content-aware image resizing technique known as “seamcarving” to resize image patches by expanding “low-energy” portions of the image (e.g., avoiding areas containing text, which may be distorted).

To fill in the “holes” left by the movement or resizing of UI elements, the electronic device 110 may employ “inpainting” techniques to generate visually-plausible replacements. The inpainted regions are unlikely to contain complex textures or structural features, because most visual content is contained inside of the UI elements themselves. The electronic device 110 may use one of a plurality of default algorithms of any suitable library.

In some embodiments, the electronic device 110 may be configured to provide a rendering approach that is noticeable and easily distinguished from unmodified app screens. For example, many UI elements are automatically or intentionally made equally-sized (e.g., elements belonging to the same list). The electronic device 110 may modify such elements differently depending on the local error.

In some embodiments, the electronic device 110 may be configured to optimize mobile app screens using corresponding pixel information to reduce the barrier to adoption of layout improvement technology, which previously must be integrated during app development. Additionally, or alternatively, the electronic device 110 may learn from a dynamic and contextual nature of mobile device usage, which may enable better personalization and adapt to users' needs more effectively.

In some embodiments, the electronic device 110 may be configured to perform a unified method of capturing interactions between difficulty and UI layout, which may improve the scoring model's reflection of real-world usage. In some embodiment, the electronic device 110 may collect additional semantic information (e.g., view hierarchy, UI type, state, tappability, and the like), which prioritize certain UI elements in optimization.

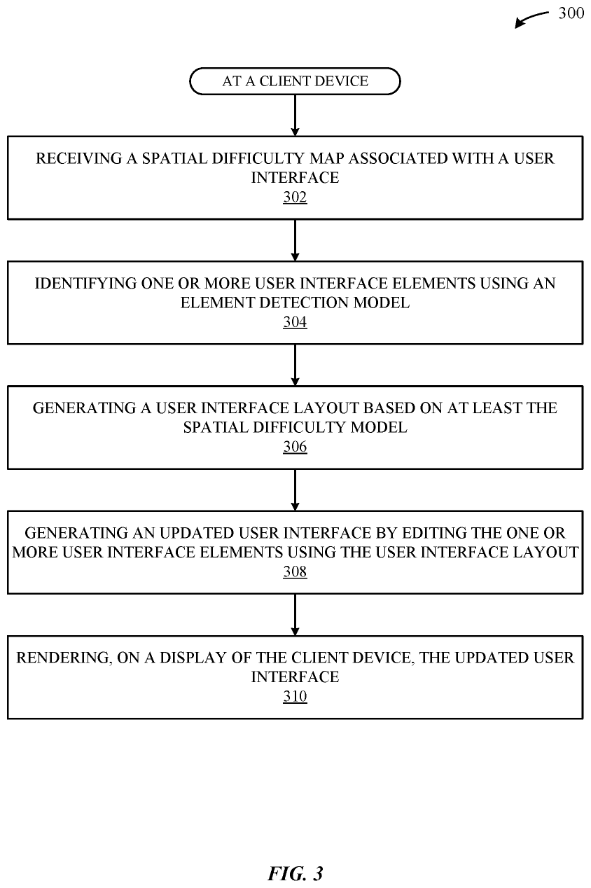

FIG. 3 illustrates a user interface personalization method 300, according to some embodiments. As shown in FIG. 3, the method 300 begins at step 302, where a client device, such as the electronic device 110, receives, receives a spatial difficulty map associated with a user interface of the electronic device 110. The spatial difficult map may be provided by a user of the electronic device 110 or retrieved from a database of spatial difficulty maps associated with the user interface.

At step 304, the electronic device 110 identifies one or more user interface elements using an element detection model. At 306, the electronic device 110 generates a user interface layout based on at least the spatial difficulty map. At 308, the electronic device 110 generates an updated user interface by editing the one or more user interface elements using the user interface layout. At 310, the electronic device 110 renders, on a display of the electronic device 110, the updated user interface.

FIG. 4 illustrates a detailed view of a computing device 400 that can be used to implement the various components described herein, according to some embodiments. In particular, the detailed view illustrates various components that can be included in the electronic device 110 illustrated in FIG. 1. As shown in FIG. 4, the computing device 400 can include a processor 402 that represents a microprocessor or controller for controlling the overall operation of computing device 400. The computing device 400 can also include a user input device 408 that allows a user of the computing device 400 to interact with the computing device 400. For example, the user input device 408 can take a variety of forms, such as a button, keypad, dial, touch screen, audio input interface, visual/image capture input interface, input in the form of sensor data, etc. Still further, the computing device 400 can include a display 410 (screen display) that can be controlled by the processor 402 to display information to the user. A data bus 416 can facilitate data transfer between at least a storage device 440, the processor 402, and a controller 413. The controller 413 can be used to interface with and control different equipment through and equipment control bus 414. The computing device 400 can also include a network/bus interface 411 that couples to a data link 412. In the case of a wireless connection, the network/bus interface 411 can include a wireless transceiver.

The computing device 400 also includes a storage device 440, which can comprise a single disk or a plurality of disks (e.g., hard drives), and includes a storage management module that manages one or more partitions within the storage device 440. In some embodiments, storage device 440 can include flash memory, semiconductor (solid state) memory or the like. The computing device 400 can also include a Random Access Memory (RAM) 420 and a Read-Only Memory (ROM) 422. The ROM 422 can store programs, utilities, or processes to be executed in a non-volatile manner. The RAM 420 can provide volatile data storage, and stores instructions related to the operation of the computing device 102.

In some embodiments, a method for personizing a user interface on a client device includes, at a client device: receiving a spatial difficulty map associated with the user interface; identifying one or more user interface elements using an element detection model; generating a user interface layout based on at least the spatial difficulty map; generating an updated user interface by editing the one or more user interface elements using the user interface layout; and rendering, on a display of the client device, the updated user interface.

In some embodiments, the method also includes generating parameters of the user interface layout using at least one of output of a scoring model out and semantic constraints. In some embodiments, the method also includes generating the scoring model using a neural network. In some embodiments, the spatial difficulty map is generated by a user of the client device. In some embodiments, the one or more user interface elements include one or more pixels associated with the user interface. In some embodiments, the client device includes a mobile computing device.

In some embodiments, at least one non-transitory computer readable storage medium is configured to store instructions that, when executed by at least one processor included in a client device, cause the client device to personalize a user interface, by carrying out steps that include: receiving a spatial difficulty map associated with the user interface of on the client device; identifying one or more user interface elements using an element detection model; generating a user interface layout based on at least the spatial difficulty map; generating an updated user interface by editing the one or more user interface elements using the user interface layout; and rendering, on a display of the client device, the updated user interface.

In some embodiments, the steps further include generating parameters of the user interface layout using at least one of output of a scoring model out and semantic constraints. In some embodiments, the steps further include generating the scoring model using a neural network. In some embodiments, the spatial difficulty map is generated by a user of the client device. In some embodiments, the one or more user interface elements include one or more pixels associated with the user interface. In some embodiments, the client device includes a mobile computing device.

In some embodiments, a client device configured to personalize a user interface includes at least one processor and at least one memory. The at least one memory stores instructions that, when executed by the at least one processor, cause the client device to perform steps that include: receiving a spatial difficulty map associated with the user interface; identifying one or more user interface elements using an element detection model; generating a user interface layout based on at least the spatial difficulty map; generating an updated user interface by editing the one or more user interface elements using the user interface layout; and rendering, on a display of the client device, the updated user interface.

In some embodiments, the steps further include generating parameters of the user interface layout using at least one of output of a scoring model out and semantic constraints. In some embodiments, the steps further include generating the scoring model using a neural network. In some embodiments, the spatial difficulty map is generated by a user of the client device. In some embodiments, the one or more user interface elements include one or more pixels associated with the user interface. In some embodiments, the client device includes a mobile computing device. In some embodiments, the user interface corresponds to a third party application executed on the client device. In some embodiments, the steps further include refining the updated user interface based on user feedback.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for personizing a user interface on a client device, the method comprising, at the client device:
receiving a spatial difficulty map associated with the user interface;
identifying one or more user interface elements using an element detection model;
generating a user interface layout based on at least the spatial difficulty map;
generating an updated user interface by editing the one or more user interface elements using the user interface layout; and
rendering, on a display of the client device, the updated user interface.

2. The method of claim 1, further comprising generating parameters of the user interface layout using at least one of output of a scoring model out and semantic constraints.

3. The method of claim 2, further comprising generating the scoring model using a neural network.

4. The method of claim 1, wherein the spatial difficulty map is generated by a user of the client device.

5. The method of claim 1, wherein the one or more user interface elements include one or more pixels associated with the user interface.

6. The method of claim 1, wherein the client device includes a mobile computing device.

7. At least one non-transitory computer readable storage medium configured to store instructions that, when executed by at least one processor included in a client device, cause the client device to personalize a user interface, by carrying out steps that include:
receiving a spatial difficulty map associated with the user interface of on the client device;
identifying one or more user interface elements using an element detection model;
generating a user interface layout based on at least the spatial difficulty map;
generating an updated user interface by editing the one or more user interface elements using the user interface layout; and
rendering, on a display of the client device, the updated user interface.

8. The at least one non-transitory computer readable storage medium of claim 7, wherein the steps further include generating parameters of the user interface layout using at least one of output of a scoring model out and semantic constraints.

9. The at least one non-transitory computer readable storage medium of claim 8, wherein the steps further include generating the scoring model using a neural network.

10. The at least one non-transitory computer readable storage medium of claim 7, wherein the spatial difficulty map is generated by a user of the client device.

11. The at least one non-transitory computer readable storage medium of claim 7, wherein the one or more user interface elements include one or more pixels associated with the user interface.

12. The at least one non-transitory computer readable storage medium of claim 7, wherein the client device includes a mobile computing device.

13. A client device configured to personalize a user interface, the client device comprising:
at least one processor; and
at least one memory storing instructions that, when executed by the at least one processor, cause the client device to perform steps that include:
receiving a spatial difficulty map associated with the user interface;
identifying one or more user interface elements using an element detection model;
generating a user interface layout based on at least the spatial difficulty map;
generating an updated user interface by editing the one or more user interface elements using the user interface layout; and
rendering, on a display of the client device, the updated user interface.

14. The client device of claim 13, wherein the steps further include generating parameters of the user interface layout using at least one of output of a scoring model out and semantic constraints.

15. The client device of claim 14, wherein the steps further include generating the scoring model using a neural network.

16. The client device of claim 13, wherein the spatial difficulty map is generated by a user of the client device.

17. The client device of claim 13, wherein the one or more user interface elements include one or more pixels associated with the user interface.

18. The client device of claim 13, wherein the client device includes a mobile computing device.

19. The client device of claim 13, wherein the user interface corresponds to a third party application executed on the client device.

20. The client device of claim 13, wherein the steps further include refining the updated user interface based on user feedback.
